(19) United States
(12) Patent Application Publication
(10) Pub. No.: US 2007/0126591 A1
(43) Pub. Date: Jun. 7, 2007

(54) Washing Machine Water Leak Prevention System

(75) Inventors: Andrew Crnkovich, Elmhurst, IL (US); Gregory Allen Ehlers, New Port Richey, FL (US)

Correspondence Address: REINHART BOERNER VAN DEUREN P.C., 2215 PERRYGREEN WAY, ROCKFORD, IL, 61107, US

(73) Assignee: ROBERTSHAW CONTROLS COMPANY, Richmond, VA (US)

(21) Appl. No.: 11/564,921

(22) Filed: Nov. 30, 2006

Related U.S. Application Data
(60) Provisional application No. 60/742,035, filed on Dec. 2, 2005.

(51) Int. Cl. D06F 37/00; D06F 39/00; G08B 21/00

(52) U.S. Cl. 340/605; 68/12.27; 68/3 R

(57) ABSTRACT

A washing machine having a leak prevention system that reduces the risk of flooding caused by a failed line or stuck water valve is provided. The leak prevention system uses a battery powered, RF enabled water valve that is attached directly to the taps used to supply water to the washing machine. Upon a call for water, the washing machine controller sends an RF signal to the supply valve, which will charge the supply line. Upon completion of the fill, the supply valve will shut off, depressurizing the line. A flow meter is also incorporated into the water train within the washing machine and monitors the amount of water entering the tub. An alarm is provided to indicate a low or dead battery or an overfill condition.

### CROSS-REFERENCE TO RELATED PATENT APPLICATIONS

This patent application claims the benefit of U.S. Provisional Patent Application No. 60/742,035, filed Dec. 2, 2005, the teachings and disclosure of which is hereby incorporated in their entireties by reference thereto.

### FIELD OF THE INVENTION

This invention generally relates to consumer and commercial appliances, and more particularly to a clothes washing machine having a leak prevention system.

### BACKGROUND OF THE INVENTION

Accidental flooding from burst washing machine supply lines and/or stuck water valves are a major source of residential property damage. As the popularity of upstairs laundry rooms has increased in recent years, so has the amount of property damage. Insurance companies and building codes are beginning to recognize this issue, requiring major structural changes for upstairs laundry rooms in new construction, such as floor drains, and increased insurance premiums.

There exists, therefore, a need in the art for a consumer and commercial clothes washing machine that has a water leak prevention system included therewith. There is also a need in the art for such a water leak prevention system that may be applied to existing washing machines.

The invention provides such a washing machine and water leak prevention system. These and other advantages of the invention, as well as additional inventive features, will be apparent from the description of the invention provided herein.

### BRIEF SUMMARY OF THE INVENTION

In view of the above, an embodiment of the present invention provides a new and improved consumer and/or commercial washing machine. More particularly, an embodiment of the present invention provides a new and improved washing machine having a leak prevention system that reduces the risk of flooding caused by a failed line or stuck water valve. Other embodiments of the invention provide a leak prevention system that may be used with existing washing machines or in other applications that require controlled water flow.

In one embodiment of the present invention, the leak prevention system utilizes a series of intelligent water valves are incorporated into the water supply and distribution system of a washing machine. This system monitors and controls its use of water to prevent major leaks and accidental flooding. The system uses a control valve coupled to the tap to control charging of the supply hose to the washing machine. This control valve is opened when the washing machine calls for water, and is preferably closed when the washing machine no longer calls for water. Communication to the control valve may be wired or wireless.

In another embodiment of the present invention, the system provides overfill prevention. This is accomplished by utilizing a flow meter to monitor the amount of water that has flowed into the wash tub. If the amount of water entering the tub, measured by the flow meter, approaches the tub's capacity, the washer controller and/or the water valve will shut off the water. If the flow meter shuts off the water supply due to a potential overflow condition, a visual and/or audible alarm will be energized, alerting the homeowner to service the machine.

In a further embodiment of the present invention, leakage during a washing cycle when a call for water is enabled is prevented by including a flow meter in the intelligent water valve to monitor the amount of water flowing from the tap. The flow meter in the washing machine measures the amount of water flowing into the tub. The controller compares these two flow meter readings to ensure that all of the water flowing from the tap is making it into the tub. If a discrepancy exists, the water valve is turned off.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view illustration of an embodiment of a washing machine with a water leak prevention system constructed in accordance with the teachings of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

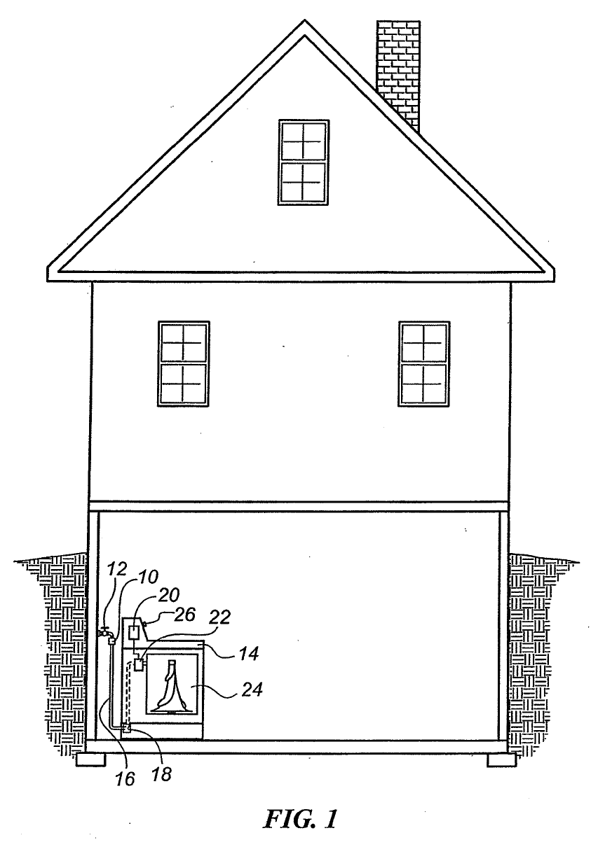

As illustrated in FIG. 1, a water supply valve 10 is attached directly to the taps 12 used to supply water to the washing machine 14. In one embodiment, the water valve 10 is battery powered and equipped for wireless communication, e.g. radio frequency (RF) enabled. In an alternate embodiment, the water supply valve 10 may be powered and/or in communication with the washing machine controller 20 via a wired connection.

Supply hoses 16 connect this water supply valve 10 to the water valve 18 on the washing machine 14. Upon a call for water, the washing machine controller 20 sends a control signal to the water supply valve 10 via a wired or wireless (e.g. RF) connection. The water supply valve 10 will open to thereby charge the supply line 16. Upon completion of the fill, the water supply valve 10 will shut off, depressurizing the line 16. As used herein, depressurizing means that the water supply valve 10 is shut off, thereby isolating the waster in the supply line 16 from the pressure in the water supply system. However, it is recognized that if valve 18 (discussed below) is closed when the water supply valve 10 is closed, a static pressure will remain in the supply line 16, and this condition is included as depressurizing the supply line.

In a further embodiment of the present invention, a flow meter 22 is also incorporated into the water train within the washing machine 14 and monitors the amount of water entering the tub 24. This flow meter 22 provides information to the washing machine controller 20 regarding the amount of water that entered the tub 24 so that the controller knows when the proper amount of water has flowed into the tub 24 and can command the water valve 18 and/or the water supply valve 10 off. In one embodiment, the flow meter 22 is integrated into the water valve 18 and/or the water supply valve 10.

In one embodiment of the present invention, the washing machine controller 20 commands the water supply valve 10 to charge the supply line 16 during the entire washing cycle, e.g. from initial fill, wash, etc. to the final rinse. The washing machine controller 20 then controls the actual flow of water in the different cycles via water valve 18 as normal. Once the washing cycle is complete, the controller commands the water supply valve 10 to depressurize the supply line 16 by closing.

In one embodiment of the present invention, the system provides overfill prevention. If the amount of water entering the tub 24, measured by the flow meter 22, approaches the tub's capacity, the washing machine controller 20 will command the water supply valve 10 to shut off the water supply. The washing machine controller 20 will also command the water valve 18 to shut off. Indeed, in one embodiment, the washing machine controller 20 will command the water valve 18 to shut off when the water dispensed into the tub exceeds a first threshold, and the water supply valve 10 when the amount exceeds a second threshold.

If the flow meter overfill condition shuts off the water supply due to a potential overflow condition, a visual and/or audible annunciation or indicator will be enabled. In one embodiment the indicator is an LED 26 that is illuminated to alert the homeowner to service the washing machine 14. In one embodiment, the washing machine 14 will continue to function in this condition because the water supply valve 10 is capable of controlling the water flow, even with a failed water valve 18.

In an embodiment of the present invention, the flow meter 22 may provide communication also to the water supply valve 10 via a wired or wireless connection. In this way, the overfill protection may be provided when the overfill condition is a result of a failed washing machine controller 20.

With the water valve 18 in place, most of the potential for flooding is eliminated. The exception will be if the washing machine 14 is running and the controller 20 requests the valve 18 be opened and the flexible hose 16 attaching the water valve 18 to the washing machine 14 ruptures. At this point, one embodiment of the washing machine 14 would hold the valve 18 open and sense the level of water in the washing tub 24 and would only shut off the valve 18 when either the correct level of water in the washing tub 24 had been reached or a time limit to complete the fill had expired. During that entire time, if the hose 16 had ruptured, water would be flooding the immediate area of the laundry room and while contained in its total time of release could cause significant damage.

To eliminate this potential the water valve 18 is fitted with a flow sensor that will monitor the flow at the tap. In conjunction with the flow meter 22 the controller 20 will ensure the water is flowing to the washer tub 24 and not escaping into the room. That is, the controller 20 will monitor the readings from both points. If a loss of flow is detected, a lock out of the water valve 18 will be initiated until the operator can inspect the situation.

Advantageously, an embodiment of the system of the present invention also provides flood prevention. As the water supply line 16 is only charged when the washing machine controller 20 calls for water, the risk of property damage is greatly reduced. This is because the supply line 16 is not pressurized when the machine 14 in unattended.

In a preferred embodiment of the present invention, a low battery warning for the water supply valve 10 is also provided. If the battery on the water supply valve 10 is low, an LED 26 is illuminated on the washing machine 14 to alert the homeowner. To allow a consumer to continue to use the washing machine 14 during a dead battery condition, e.g. if the battery on the water supply valve 10 fails, one embodiment of the present invention opens the water supply valve 10 allowing the washing machine 14 to function normally, albeit with the risk of flooding if the supply line 16 or water valve 18 fail.

In one embodiment, the leak prevention system is provided as an aftermarket accessory kit that can be sold separately to consumers. This kit includes the water supply valve 10 and an interface to the controller 20 of the washing machine 14. This interface may provide a wired connection to the water valve 18 control line from the controller, or may provide an RF transmitter. Once installed, the interface would provide the command signal to the water supply valve 10 to charge the line 16 when the controller 20 calls for water. The interface would then command the water supply valve 10 off when the controller 20 no longer calls for water.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A washing machine comprising a leak prevention system coupled to a water supply line, the leak prevention system depressurizing the water supply line when the washing machine is not calling for water.

2. The washing machine of claim 1, wherein the leak prevention system comprises a water supply valve in communication with a washing machine controller, the washing machine controller configured to command the water supply valve to open when water is needed and to command the water supply valve to close when water is not needed.

3. The washing machine of claim 2, wherein the water supply valve and the washing machine controller are configured for wireless communication.

4. The washing machine of claim 2, wherein the water control valve is adapted to connect to a water tap between the water supply line and the water tap.

5. The washing machine of claim 2, further comprising a water valve in series with the water supply valve.

6. The washing machine of claim 5, wherein the controller is configured to open the water supply valve at the beginning of a washing cycle.

7. The washing machine of claim 6, wherein the controller is configured to control a flow of water during the washing cycle by opening and closing the water valve.

8. The washing machine of claim 7, wherein the controller is configured to close the water supply valve at the end of a washing cycle.

9. The washing machine of claim 6, wherein the controller is configured to close the water supply valve after a final need for water during a washing cycle.

10. The washing machine of claim 2, further comprising a water flow meter positioned to measure a flow of water into a tub of the washing machine.

11. The washing machine of claim 10, wherein the water flow meter is in communication with the washing machine controller, the washing machine controller configured to close the water supply valve when an amount of water dispensed into the tub exceeds a threshold.

12. The washing machine of claim 10, further comprising a water valve in series with the water supply valve, and wherein the water flow meter is in communication with the washing machine controller, the washing machine controller configured to close the water valve when an amount of water dispensed into the tub exceeds a first threshold.

13. The washing machine of claim 12, wherein the water supply valve includes a water supply flow meter, and wherein the washing machine controller monitors the water supply flow meter and the water flow meter, and wherein the washing machine controller is configured to close the water supply valve when a difference between the water supply flow meter and the water flow meter exists.

14. The washing machine of claim 11, further comprising an indicator, and wherein the controller energizes the indicator when the amount of water dispensed into the tub exceeds the threshold.

15. The washing machine of claim 14, wherein the indicator is at least one of an audible indicator and a visual indicator.

16. The washing machine of claim 2, wherein the water supply valve is battery powered.

17. The washing machine of claim 16, further comprising an indicator, and wherein the controller energizes the indicator when the water supply valve signals a low battery condition.

18. The washing machine of claim 16, where the controller is configured to open the water supply valve when the water supply valve signals a low battery condition.

19. A leak prevention system for use with a washing machine, comprising:
a water supply valve adapted to be interposed between a water supply tap and a washing machine supply line, the water supply valve configured to communicate with a washing machine controller;
a communication interface adapted to utilize a control signal from the washing machine controller to control a water valve of the washing machine; and
wherein communication interface transmits an open command to the water supply valve when the washing machine controller commands the water valve to open when water is needed and to transmit a close command to the water supply valve when the washing machine controller commands the water valve to close water is not needed.

20. The leak prevention system of claim 19, further comprising a tub flow meter positioned to monitor a flow of water into the washing machine tub, and wherein the water supply valve includes a water supply flow meter, the washing machine controller operatively coupled to the tub flow meter and the water supply flow meter, and wherein the washing machine controller is configured to close the water supply valve when a difference between the water supply flow meter and the tub flow meter exists.
